(19) United States
(12) Patent Application Publication
(10) Pub. No.: US 2021/0089896 A1
(43) Pub. Date: Mar. 25, 2021

(54) Automated Image Processing System for Garment Targeting and Generation

(71) Applicant: Savitude, Inc., Palo Alto, CA (US)

(72) Inventors: Nicholas Daniel Clayton, Ypsilanti, MI (US); Camilla Marie Olson, Palo Alto, CA (US); Jungah Joo Lee, Oswego, OR (US); Sheng Liu, Ann Arbor, MI (US)

(21) Appl. No.: 16/997,917

(22) Filed: Aug. 19, 2020

Related U.S. Application Data
(60) Provisional application No. 62/888,961, filed on Aug. 19, 2019.

(51) Int. Cl. G06N 3/08; G06N 3/04; G06K 9/46; G06K 9/62

(52) U.S. Cl. CPC G06N 3/08; G06K 9/6259; G06K 9/4604; G06N 3/0454

(57) ABSTRACT

An image processing system with a trained neural network examines images to identify design elements present in objects depicted in those images. The image processing system can evaluate a set of images, some of which have been labeled or associated with bins of a set of bins, to identify differences between an actual distribution among the set of bins and a target distribution among the set of bins. From the differences, a second trained neural network, or other computer process, can evaluate the distributions to determine garments or garment features that are underrepresented or overrepresented in the set of images.

### RELATED APPLICATION

The present application claims priority to U.S. Application No. 62/888,961, entitled “Garment Record Generation In A Design Process,” filed on Aug. 19, 2019, incorporated herein by reference.

### FIELD OF THE INVENTION

The present disclosure generally relates to image processing. The disclosure relates more particularly to apparatus and techniques for processing images to extract features of wearable items as might be used for creating new wearable items.

### BACKGROUND

Designing garments specifically, and wearable items more generally, using computers can be a manual and laborious process. A designer might have to manually study many examples of items, such as collections of garments having various features, to determine what garment features might be underrepresented or overrepresented in the collection of garments. An automated system that can assess images of wearable items to distill characteristics of the wearable items depicted in the images and/or wearable items that invoke items depicted in the images would be desirable.

### SUMMARY

An image processing system might be configured with a trained neural network or an artificial intelligence process that can examine images to identify design elements present in objects depicted in those images. The image processing system might also be configured to evaluate a set of images, some of which have been labeled or associated with bins of a set of bins, to identify differences between an actual distribution among the set of bins and a target distribution among the set of bins. From the differences, a second trained neural network, or other computer process, can evaluate the distributions to determine garments or garment features that are underrepresented or overrepresented in the set of images.

In a specific embodiment, an input image set comprises a large number of images that each depict a garment or another wearable item, or an object or scene that includes design details representable in a garment or another wearable item. The input image set might be images of clothing in a clothing collection wherein the clothing is clothing created for particular body shapes, images of clothing in a clothing collection wherein the images are selected by a process, manual or otherwise, that identifies images of popular and/or trending wearable items, and/or images of clothing or other objects that can be used as inspirations for clothing or other wearable items. The image processing system can process the input image set to determine distributions of images. The distributions might comprise a plurality of bins from a bin set, and the bin set might have more than one dimension. An image might appear it more than one bin.

From the distributions and the particular bin sets, proposed garment details can be derived, such as to determine a proposed garment that would otherwise be underrepresented in the input image set. A garment collection could be automatically generated from such proposed garment details.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 shows examples of garment design.

FIG. 2 shows examples of garment design.

FIG. 3 illustrates aspects of a design studio computer system.

FIG. 4 illustrates a design evaluator that determines a proposed garment detail from available inputs.

FIG. 5 illustrates a collection distillation processor capable of determining garments to add to a garment collection based on available inputs.

FIG. 6 illustrates a collection distillation processor capable of determining garments to add to a garment collection based on available inputs including a target body shape distribution.

FIG. 7 illustrates an example of an image depicting various garments.

FIG. 8 illustrates an example of determining regions of an image that correspond to garments depicted in the image.

FIG. 9 illustrates an example of labels applied to garments detected in an image.

FIG. 10 illustrates an example of a structured data record representing a distribution of values for determining various bins for elements depicted in the image of FIG. 9.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A generation process for generating a garment data record representing a garment from an input set will now be described. As used herein, an input set might be in the form of a data record representing a set of images either unstructured, or structured as an assortment (with multiple images of the same garments from different angles, in different colors/patterns, etc.). The image sets might also include images not of specific garments but any type of image either with no context given or with some context as to which design details this image correlates to. For example, an input image of a sunset might be labeled as relating to color while an image with strong lines might be labeled as relating to details such as silhouette or neckline.

An input set might be used by a designer that wants to match an assortment to a shape of their customer population. Their customer population could be a predefined population, a national population, a regional population, a global population, or other population. The input data might include data representing further guidance such as data representing a general form of specific directions or limitations on the assortment. For example, a specific silhouette might be desired or a specific fabric or pattern might be used, or some limitations might be placed on the number of different types of garments that can be generated, to simplify the manufacturing process or for other reasons.

From the input set, the system might generate a set of weights and constraints that would be used by a generation process. For example, in the case of the input images, a frequency of particular design details (silhouette, neckline, color, pattern, etc.) might be considered as a weight, where design details that occur with higher frequency would be weighted higher. Similarly, the frequency of combinations of two or more design details could be used as a weight. This would generally be limited to pairing for the sake of computational complexity but might be expanded for sets of design details that are particularly strongly intertwined, such as necklines, shoulders and sleeves. Design detail pairings that work well together might also be drawn from a knowledge base or from a larger set of garment images. In the case of images not of a particular garment, a similar image analysis can be applied either across all design details or across those given as context. When no context is given, the design details with the highest posterior probability might be selected as the “design” of that image.

In the case of input customer shape data, design details that fit the overall population or best serve some subset of that population (perhaps simply the largest subset, or perhaps the subset worst served by existing garments or designs whether real or previously generated).

This subset could even be a single customer to design with a specific customer in mind in some custom clothing applications. Where limitations are required, some subset of the possible design details might be selected to limit the generation. For example, if there are some number of commonly occurring silhouettes, one or more might be selected that provide an optimal coverage for the shape population.

In many examples herein, images are of garments and an output is a garment design. It should be understood that, unless otherwise indicated, the apparatus and techniques described herein could be used for other wearable items not normally considered garments and thus this description is not limited to garments.

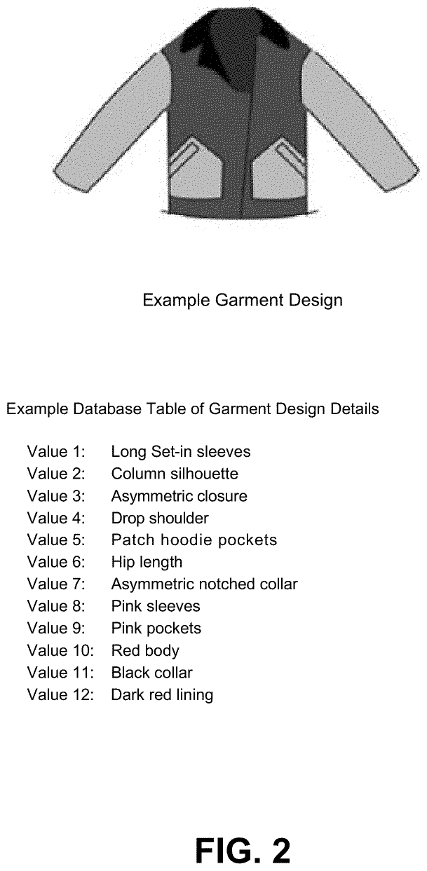

A garment data record might include data representing a set of design details, as illustrated in FIG. 2. This might be created by analyzing possible combinations of design details and finding an optimally weighted overall design. Where the design space is too large for this to be computationally feasible, garment data records can be generated by adding one (or more, but typically one) design detail at a time and selecting an optimized weighted option for the particular design detail, where option weight might be determined by evaluating the design detail in combination with existing design details already in the garment design record. If more variety or spontaneity is desired, this can be altered to select more or less arbitrarily from a top N (where N is an integer >=1) design details or design details that alter the garment's weight by some amount over a certain threshold either as an absolute real number or a fraction of an existing weight of the garment.

This might be repeated until one option has been picked for each design detail in the garment data record. The result is a garment description record that might take a form such as the following for a dress (a-line silhouette, v-neck, drop shoulder, blue body, black sleeves, knee length, etc.).

For each garment design generated a “flat image” of the design can be generated as follows. First, for each design detail (possibly excluding pattern and color), a set of contours that represent those design details is created around a standard form. For each of these contours, where it is known that a particular segment of them will be facing the interior or exterior of the garment, this is marked on the edge of the contour. In an image representation used to store these contours, this can be represented with red and blue and white pixels by the contour where red pixels represent interior, blue represents exterior, and white represents ambiguous or unknown (as might be the case for the representation of a shoulder, where one side facing the torso will always be interior, but the other may be interior in the case of a garment with sleeves and exterior in the case of a garment without). Other color representations or other representations might be used for visual displays.

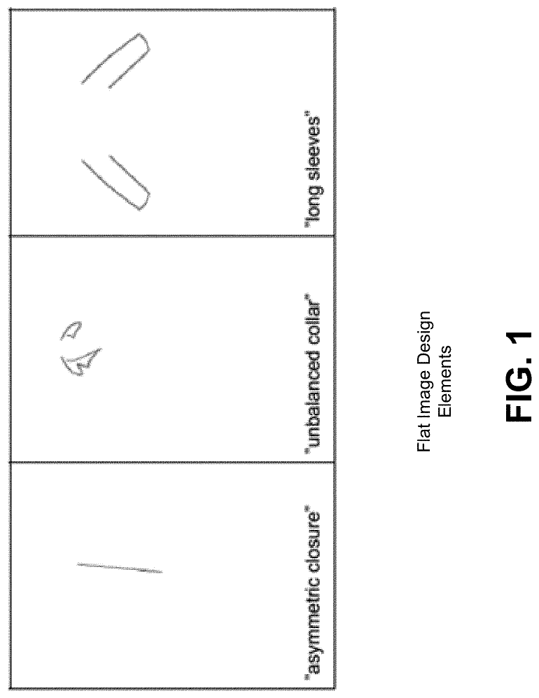

The endpoints of these contours can be explicitly marked as they are created or they can be inferred from the transition between interior, exterior and unknown sections of the contour. This is illustrated in FIG. 1.

For a given garment design, contours for design details in that design can be placed on the same image. A gap closure algorithm can then be used to first connect exterior endpoints (any endpoint adjacent to contours marked as exterior) to other nearby exterior endpoints (not on the same contour) or directly to an exterior contour where no exterior endpoint is available. The same process can then be repeated with interior endpoints. These closure lines can be drawn, but in general are used to define regions. These regions created by the closures and the contours are then marked as either interior to the garment or exterior to the garment, based on the interior/exterior markings on their component contours where a region with more pixels marked as interior or exterior would be marked as interior or exterior respectively, and a region with even, close to even, or none can be marked as ambiguous or unknown. These might typically be seen where the inner liner of a garment might be seen, such as behind the collar of a jacket. Interior regions can be labeled by their component contours if necessary for a fill step. For example, the interior regions most defined by the sleeve contour might be labeled “sleeves”.

Each region can then be filled with the appropriate color and/or pattern based on the garment design to generate the display. In the given example, the regions marked “sleeve” would be filled with black pixels while all other interior regions would be marked blue, or some other color scheme would be used.

This is illustrated in FIG. 2. As shown there, an example database table of garment design details might hold the following values:

Value 1: Long Set-in sleeves

Value 2: Column silhouette

Value 3: Asymmetric closure

Value 4: Drop shoulder

Value 5: Patch hoodie pockets

Value 6: Hip length

Value 7: Asymmetric notched collar

Value 8: Pink sleeves

Value 9: Pink pockets

Value 10: Red body

Value 11: Black collar

Value 12: Dark red lining

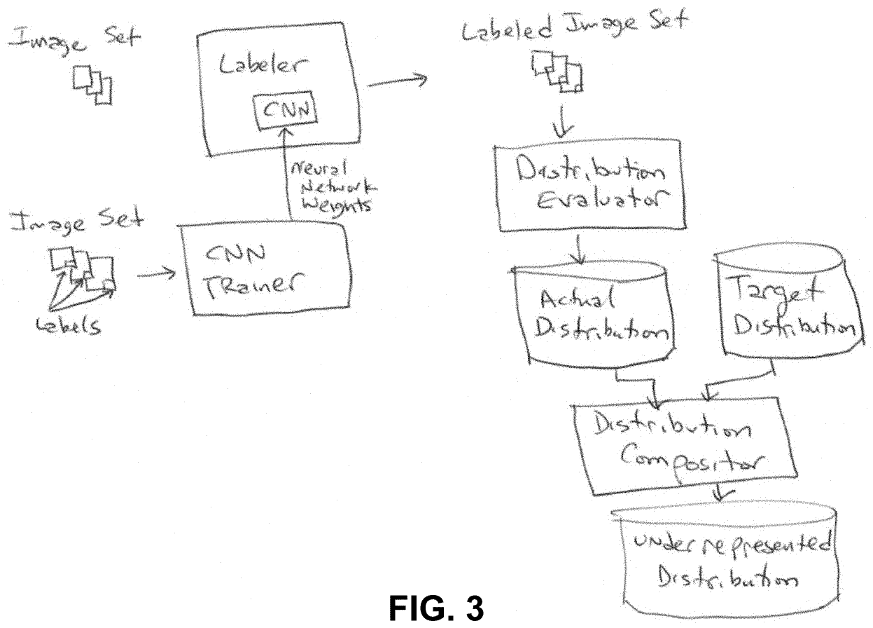

FIG. 3 illustrates elements of a design studio computer system as might be used by designers to assist with the design of garments, based on design inspiration features extracted from images, features found to be missing from a collection of garments, or other inputs. In an embodiment, the design studio computer system can receive a collection of images from a designer, some of which might be labeled, and output direction for designers and merchandisers to build garment collections that can meet certain requirements, such as fitting their customer base and provide a robust collection from which their customer base can select. This can result in reduced return rates and reduced excess inventory.

In an embodiment, the design studio system provides for a computer-implemented method for processing clothing inventory images, trend images, and/or inspiration images, under the control of one or more computer systems configured with executable instructions for obtaining designer inputs, obtaining retailer inputs, training a neural network with garment images as input data and design detail labels as ground truth data, to form a trained neural network, and determining a collection of clothing items from the image data based on the designer inputs and the retailer inputs, using the trained neural network. Determining might be done by (a) identifying labels for images in an image set or probabilities of labels (i.e., neckline: 40% v-neck, 60% crew), color groupings by clustering, color groupings by named color space (i.e., red, blue, cyan, lavender, etc.), and determining distributions over the image sets, such as existence of particular design details in a garment, and/or probabilities of the presence of one or more other details (i.e., P(vneck|a-line) or P(vneck|sleeveless & blue)). By determining bin labels for the images, they can be grouped into groups of images.

A trained neural network can determine the groups, wherein the trained neural network might determine that the groupings are similar, given the plurality of input data records, to patterns of occurrence rates in the inputs, and targeting body shape distributions using a knowledge base.

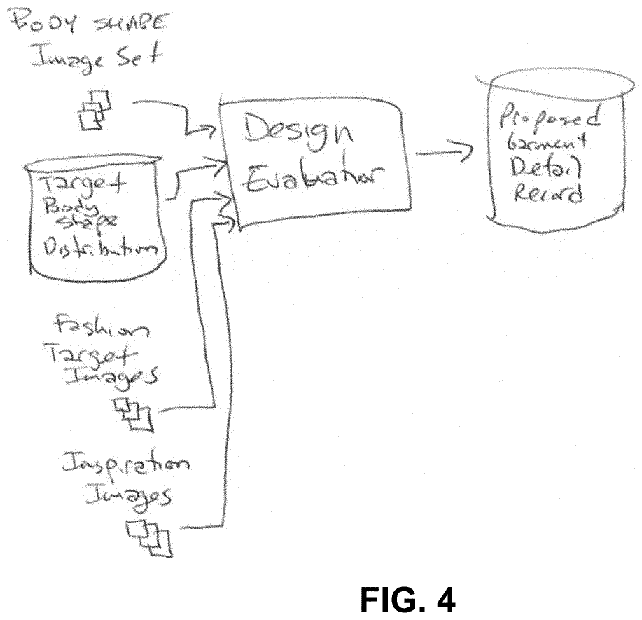

FIG. 4 illustrates a design evaluator that determines a proposed garment detail from available inputs. FIG. 4 illustrates how a garment detail record might be generated to propose a new garment based on inputs such as a set of images that represent a particular body shape, a dataset of a target body shape distribution, a set of fashion target images, and/or a set of inspiration images. A design evaluator might generate the proposed new garment to meeting one or more targets:

1) a body shape distribution target. The target might be a population of body shapes in a particular geographic region, based on shopping patterns of a particular retailer, within some demographic (i.e., age range), etc. It can also take the form of an underrepresented population based on computing a subset of a body shape population that is underrepresented in a garment collection represented by an image set.

2) An inspiration target. For this, the system is provided a set of inspiration images, which are analyzed by convolutional neural networks. These may or may not not contain actual design details and might not depict clothing. Whether an image is said to have a particular design detail might be based on a determined confidence value for that design detail, whether it is above some threshold (i.e., 0.7 probability) or is the highest confidence value in a given category. The set of images can be binned as described above.

3) A fashion target. For this, the system is provided s set of images, perhaps of what a designer deems to be on trend garments or fashionable items. These can be images of clothes from various sources. These image sets are analyzed for what design details are present and can be binned as described herein and used to generate new garment records.

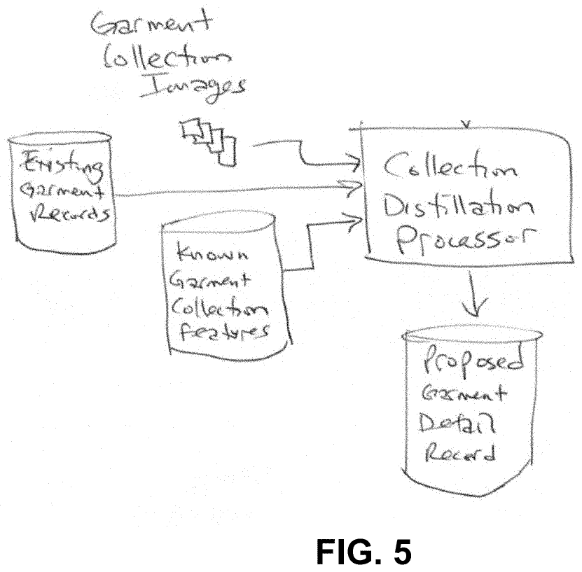

FIG. 5 illustrates a collection distillation processor capable of determining garments to add to a garment collection based on available inputs. FIG. 5 also illustrates a process whereby gaps in a garment collection can be identified. The image set might be analyzed for what design details are present and their distributions compared to target distributions, which might represent a particular brand's usual distribution. This can be calculated based on past collections or on a set of input images to determine particular design details that are always or almost always present in the brand. For example, if a brand has at least one wrap dress in every collection, the design studio system might propose such garments. In some cases, such as the case of a new brand with no prior collections, the brand may prefer to manually configure such constraints rather than deriving them through image analysis. This brand “DNA” record can evolve over the creation of a collection similar to an under-served body shape record by removing brand DNA elements already present in the collection.

A garment record can be created as follows:

1. Each input set is weighted fractionally by the user (e.g., inspiration=0.5, trend=0.3, body shape=0.2) to determine which inputs are most important.

2. A record set is initialized.

3. A feature is selected either at random or sequentially from the required set not yet present in the garment record (i.e., silhouette, neckline, print, colors, etc.)

4. For each feature to be added the weighted probability of each feature is calculated (based on the weights defined in 1) and a feature is selected based on those weights (either a weighted random, a weighted random selection between the top N options, or simply the most probable option), to be added to the record. For example, the design studio might have a partial record of [v-neck, a-line] and account for a type of sleeve from [sleeveless, cap, bishop] for each option and for each input set, a score is calculated. In the case of a body shape population, this score might be the portion of the population that detail helps serve. In the case of an inspiration image set, brand DNA set, or trend set, this could be calculated as X*P(sleeveless)±(1−X)*P(sleeveless|v-neck & a-line), where X is determined by the user. P(sleeveless|v-neck & a-line) can be calculated with a naive Bayesian model for computational efficiency, but it can also be directly computed from the input image sets.

In an example where the scores came out to a distribution of sleeveless=0.7, cap=0.2, and bishop=0.1, the design studio system might select randomly with that probability distribution or depending on the configuration, it might select sleeveless as the highest scored feature. A semi-random selection allows for greater diversity in generated garments for a particular set of inputs.

5. The selection of another feature and determining its probability distribution is repeated for other features.

A garment collection can be created as follows:

1. Each input set is weighted fractionally by the user (i.e inspiration=0.5, trend=0.3, body shape=0.2) to determine which inputs are most important.

2. Starting with an empty set of garments.

3. A garment can be generated as described above and added to the garment collection.

4. Brand DNA can be updated to reflect the “missing DNA” in the current set of garments and the targeted body shape population can be calculated as the under-served population of the original target population given the current set of garments.

5. Steps 3 and 4 can be repeated until the desired number of garments have been reached or the under-served body shape population has reached some minimum threshold and/or the missing DNA has reached some minimum threshold. If it is desired to both constrain the number of garments and optimize the under-served body shape population and/or missing brand DNA, the garment record or records that least contributes to those metrics (as calculated by calculating the delta in the absence of that particular record) can be removed to make room for new records once the target number of records has been reached.

This optimization can end after a fixed number of allowed iterations or manual stopping.

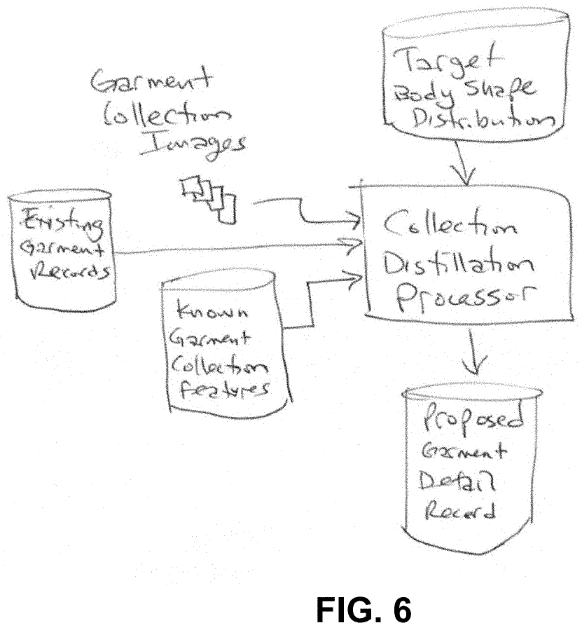

FIG. 6 illustrates a collection distillation processor capable of determining garments to add to a garment collection based on available inputs including a target body shape distribution.

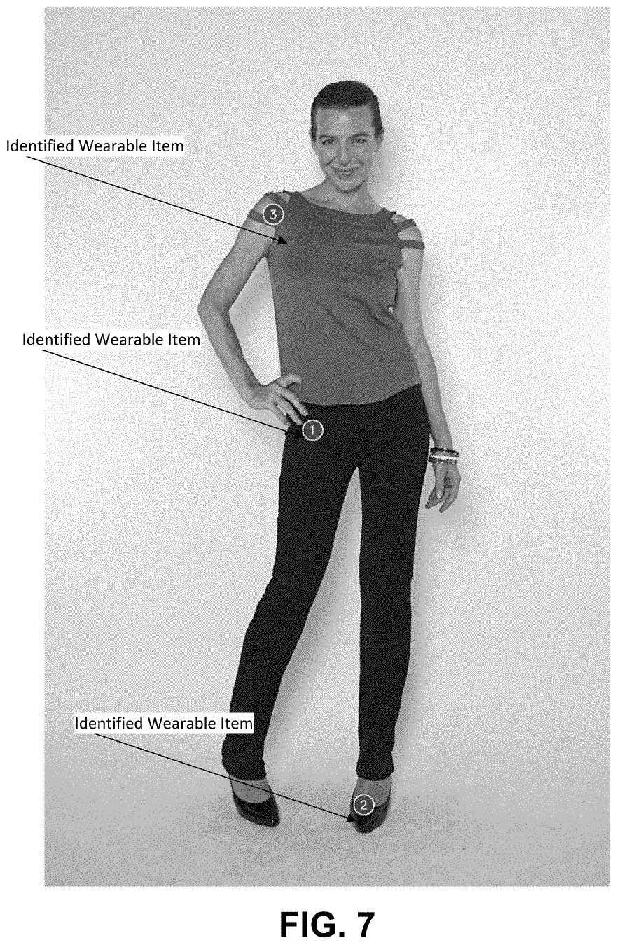

FIG. 7 illustrates an example of an image depicting various garments.

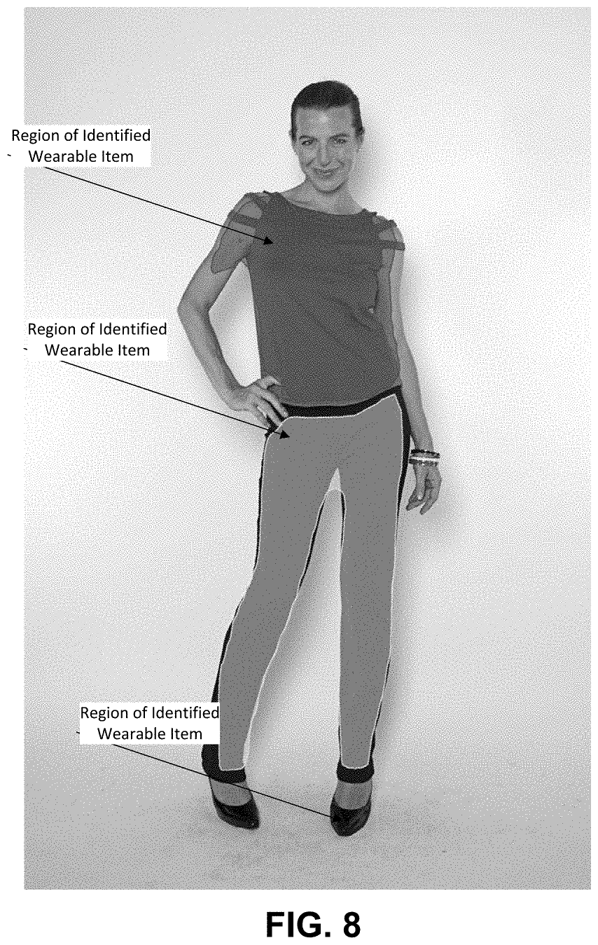

FIG. 8 illustrates an example of determining regions of an image that correspond to garments depicted in the image.

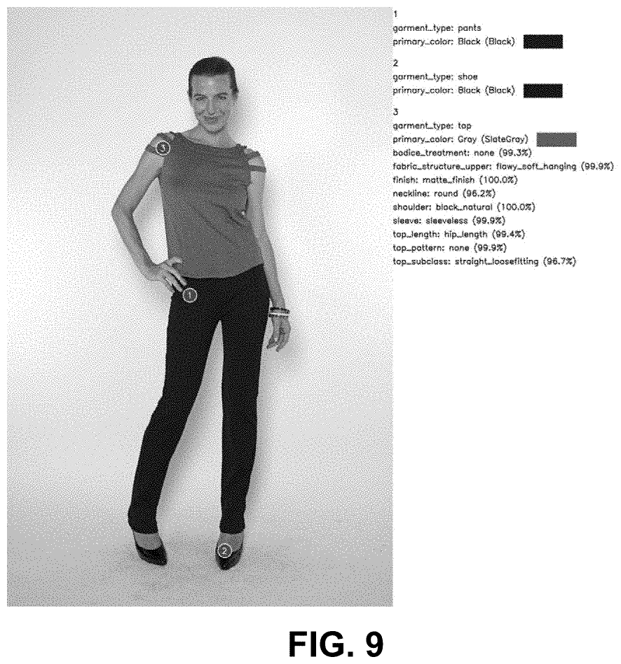

FIG. 9 illustrates an example of labels applied to garments detected in an image.

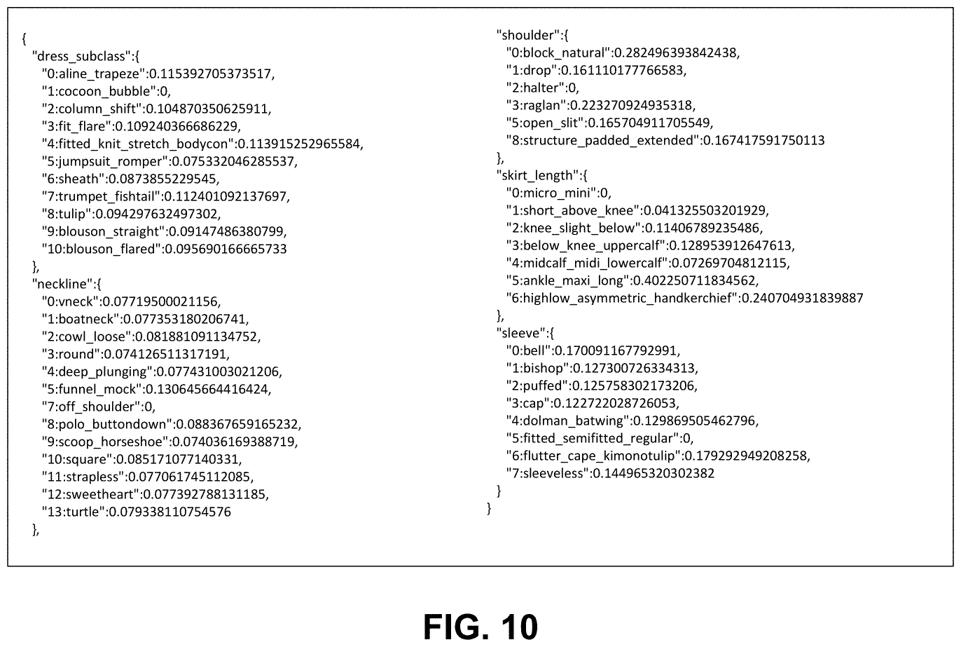

FIG. 10 illustrates an example of a structured data record representing a distribution of values for determining various bins for elements depicted in the image of FIG. 9.

### Examples of Operations

The design studio system might be able to determine the features of a garment that is “missing” from a collection of garments depicted in a collection of images, knowing a target distribution over some set of bins. In another process, the inputs are a set of images where each image has two sets of labels. One set of labels specifies the rationale for inclusion of an image (e.g., “this image is included 30% because it is an inspiration, 70% because it seems to be trendy” or “this image is included because it depicts a body shape of interest”). In some embodiments, a given image is only for one rationale. Another set of labels specifies which bin or bins the image belongs in. This second set of bins could have multiple orthogonal sub-bins (e.g., one set of sub-bins is for the different colors a garment in the image could be assigned to, one set of sub-bins is for the different necklines a garment in the image could be assigned to, etc.). The output of this process can be a list of features that a garment—previously nonexistent—should have.

Two separate CNN might be used, where the first is trained to select regions of an image and identify them as particular garments (see, e.g., FIG. 8), while the second CNN can take an unlabeled input image and classify a particular category of design detail (e.g., neckline) and output a set of probabilities associated with each label such as “8:none_collarless: 0.42744162876206565”. For this second CNN, there can be many trained networks, each of which is trained to identify a separate category of design detail, each of which runs on each image (or region of image). In the case of a region identified as a particular type of garment (e.g., jacket), the design studio software might run only the classifiers for the types of design details that a garment will have (e.g., not run the neckline classifier for a region identified as pants). For inspiration images where no garments are identified in the image, the system instead can instead run every classifier and take only results where the highest probability is above a pre-defined threshold.

The comparison of a garment design to a body shape can be done as described in U.S. patent application Ser. No. 15/980,493, which is incorporated herein for all purposes. A score might be used as a metric to guide garment generation, or some other metric that allows a partial garment description of one or more design details to be scored versus a particular body shape might be used.

Examples of bin distributions might be that for a group of 50 images, it has 10 marked v-necks, 30 marked scoop-necks, and 10 marked crew-necks. This image set would be 60% scoop-neck, 20% v-neck, and 20% crew-neck. Similarly, an image set might be labeled images where 50 were marked as a-line silhouettes and of those 50 marked as a-line 20 has v-necks. In this case P(v-neck|a-line)=0.4=40%.

When looking at an image instance segmentation techniques are used to identify regions of the image that represent a single garment, the features of that garment might be categories, or if no garments are found, the image treated as a whole as one single garment of unspecified type and attributes are selected from it that are labeled with high confidence.

The proposed garment detail record can be fed to a sketching system to assist with garment generation. An example record might be [dress, a-line, v-neck, sleeveless, knee-length, red, #ff0000, etc.].

For brand DNA, the system might consider a design detail profile that is described by the brand DNA and subtract the design details already present in the collection. For example, where a brand always makes three dresses, one a-line, one tulip and one sheath and the brand image collection has two dresses, one a-line and one sheath, the system would compute (0.33 a-line, 0.33 tulip, and 0.33 sheath) and subtract (0.5 a-line and 0.5 sheath) (flooring to 0) and end up with (0.33 tulip, 0 a-line and 0 sheath). Normalizing, this would be (1.0 tulip, 0 a-line, 0 sheath). For body shape, the system can take the target body shape population, a simplified model of which might be 50% bottom-hourglass and 50% hourglass and subtract from it the body shapes that are currently well served by the collection. So if hourglass body shapes are already well served in the assortment, the proposed garments might be 100% bottom-hourglass.

Other variations are contemplated.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for processing an image set comprising a plurality of images to identify at least one grouping comprising two or more grouped images of the image set, wherein the image set comprises at least two images each depicting one or more clothing items, the method comprising:
under the control of one or more computer systems configured with executable instructions:
obtaining a first set of data, representing designer associations of a first set of design detail labels with first selected labelled images of the image set;
obtaining a second set of data, representing retailer associations of a second set of design detail labels with second selected labelled images of the image set;
training a neural network with the first selected labelled images of the image set and the second set of design detail labels used as input data to the neural network and the first set of design details labels used as ground truth data for training the neural network, to form a trained neural network usable to determine likely design detail labels for unlabeled images of the plurality of images;
determining a collection of selected unlabeled images using the trained neural network, wherein the selected unlabeled images are deemed by the trained neural network to have design details in common without requiring explicit design detail labeling; and
storing a collection data structure specifying the collection of selected unlabeled images.

2. The computer-implemented method of claim 1, wherein the plurality of images comprises one or more of an inventory image depicting an item of inventory, a trend image depicting an actual or expected trend in fashion, and/or an inspiration image depicting a possible article of clothing.

3. The computer-implemented method of claim 2, wherein training a neural network further comprises providing weights representing relative weighting of images based on an inventory weight for each inventory image, a trend weight for each trend image, and/or an inspiration weight for each inspiration image.

4. The computer-implemented method of claim 1, wherein the first selected labelled images of the image set and the second selected labelled images of the image set have images in common.

5. The computer-implemented method of claim 1, wherein determining the collection of selected unlabeled images comprises initially grouping the plurality of images into collections, wherein the collections are grouped based on characteristics determined from objects depicted in the plurality of images.

6. The computer-implemented method of claim 5, wherein characteristics determined from objects depicted in the plurality of images comprise one or more of (a) garment color, (b) garment color grouping, (c) occurrence of a first category of design detail in a garment given presence of one or more second category of design detail, and/or (d) determined body shape distribution.

7. The computer-implemented method of claim 1, further comprising:
determining, from the collection of selected unlabeled images, a body shape population for the collection;
obtaining a body shape population target; and
adjust the collection to align the body shape population for the collection with the body shape population target.

8. The computer-implemented method of claim 7, further comprising repeating adjusting of the collection until the body shape population for the collection reaches a pre-determined threshold.
